(19) United States
(12) Patent Application Publication
(10) Pub. No.: US 2012/0042390 A1
(43) Pub. Date: Feb. 16, 2012

(54) METHOD AND APPARATUS FOR SECURE REVOCABLE LOCATION SHARING

(75) Inventor: Tochukwu Iwuchukwu, Mountain View, CA (US)

(73) Assignee: Nokia Corporation, Espoo (FI)

(21) Appl. No.: 12/855,367

(22) Filed: Aug. 12, 2010

(51) Int. Cl. G06F 21/00; G06F 15/16

(52) U.S. Cl. 726/27

(57) ABSTRACT

Techniques for a secure revocable location sharing network service include determining a first identifier for a subscriber at a first service. A location access key stored at a second service in association with a second identifier for the subscriber is determined. At least one ciphered location is determined based on the location access key and at least one location associated with the subscriber. It is determined to send the at least one ciphered location to the first service in association with the first identifier. In some embodiments, the first identifier and second identifier are identical. Another technique includes associating a subscriber with an access key and an identifier at a first service for contacts. However, the access key is not associated with the subscriber at the first service.

### BACKGROUND

Service providers and device manufacturers (e.g., wireless, cellular, etc.) are continually challenged to deliver value and convenience to consumers by, for example, providing compelling network services. A widely popular class of network services includes social networking services in which subscribers identify each other as members of a circle of friends and share posted text, audio, photographs, video, World Wide Web links and other information. Some of the shared information includes geospatial location data, such as a home, school or work address or some meeting place and time for a subscriber. As more subscribers carry mobile devices with global positioning system (GPS) receivers, the subscribers' current and past locations can also be tracked and shared by a location sharing service (LSS) of the social networking service. As intriguing and useful as location-sharing services may be, they pose a privacy problem to users. A user's current or recent location can be exposed to employers or clients or antagonists or creditors or government agencies as a result of the practices of the LSS or from a breach into the LSS system. Such exposure might sometimes be undesirable. Some systems prevent a subscriber's location from being revealed to the LSS by encrypting the subscriber's location. However such systems require the subscriber to send a decryption key to each friend who is privileged to share the location data; and do not provide for revocation of location sharing privileges.

### SOME EXAMPLE EMBODIMENTS

Therefore, there is a need for an approach for a secure revocable location sharing network service.

According to one embodiment, a method comprises determining a first identifier for a subscriber at a first service. The method also comprises determining a location access key stored at a second service in association with a second identifier for the subscriber. The method further comprises determining at least one ciphered location based on the location access key and at least one location associated with the subscriber. The method still further comprises determining to send the at least one ciphered location to the first service in association with the first identifier.

According to another embodiment, a method comprises receiving at least one location sharing invitation message indicating a first identifier for a corresponding subscriber at a first service and a second identifier for the subscriber at a second service. The method further comprises determining to send, to the second service, a request for an access key associated with the second identifier. The method further comprises receiving a contact access key in response to sending the request.

In some embodiments, the second identifier for the subscriber is identical to the first identifier for the subscriber.

According to another embodiment, a method comprises determining to associate a first identifier for a subscriber with an access key and at least one second identifier at a first service for at least one contact of the subscriber. However, the access key is not associated with the first identifier at the first service.

According to another embodiment, an apparatus comprises at least one processor, and at least one memory including computer program code, the at least one memory and the computer program code configured to, with the at least one processor, cause, at least in part, the apparatus to determine a first identifier for a subscriber at a first service. The apparatus is also caused to determine a location access key stored at a second service in association with a second identifier for the subscriber. The apparatus is further caused to determine at least one ciphered location based on the location access key and at least one location associated with the subscriber. The apparatus is also caused to determining to send the at least one ciphered location to the first service in association with the first identifier.

According to another embodiment, an apparatus comprises at least one processor, and at least one memory including computer program code, the at least one memory and the computer program code configured to, with the at least one processor, cause, at least in part, the apparatus to receive at least one location sharing invitation message indicating a first identifier for a corresponding subscriber at a first service and a second identifier for the subscriber at a second service. The apparatus is further caused to determine to send, to the second service, a request for an access key associated with the second identifier. The apparatus is further caused to receive a contact access key in response to sending the request.

According to another embodiment, an apparatus comprises at least one processor, and at least one memory including computer program code, the at least one memory and the computer program code configured to, with the at least one processor, cause, at least in part, the apparatus to determine to associate a first identifier for a subscriber with an access key and at least one second identifier at a first service for a contact of the subscriber. The access key is not associated with the first identifier at the first service.

According to another embodiment, a method comprises facilitating access to at least one interface configured to allow access to at least one service, the at least one service configured to perform at least one of the above methods.

According to another embodiment, a computer-readable storage medium carries one or more sequences of one or more instructions which, when executed by one or more processors, cause, at least in part, an apparatus to perform at least one of the above methods.

According to another embodiment, a computer program product includes one or more sequences of one or more instructions which, when executed by one or more processors, cause an apparatus to at least perform one of the above methods.

According to another embodiment, an apparatus comprises means for performing steps of one of the above methods.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of secure revocable location sharing, according to one embodiment;

FIG. 2A is a diagram of a subscriber profiles data structure, according to one embodiment;

FIG. 2B is a diagram of a location access keys data structure, according to one embodiment;

FIG. 2C is a diagram of a cached access keys data structure, according to one embodiment;

FIG. 2D is a diagram of a location share invitation message, according to one embodiment;

FIG. 3 is a time sequence diagram of messages exchanged to provide secure revocable location sharing, according to an embodiment;

FIG. 4 is a flowchart of a process for location key service, according to one embodiment;

FIG. 5 is a flowchart of a process for location privacy management, according to one embodiment;

FIGS. 6A-6B are diagrams of user interfaces utilized in the processes of FIG. 5, according to various embodiments;

FIG. 7 is a diagram of hardware that can be used to implement an embodiment of the invention;

FIG. 8 is a diagram of a chip set that can be used to implement an embodiment of the invention; and

FIG. 9 is a diagram of a mobile terminal (e.g., handset) that can be used to implement an embodiment of the invention.

### DESCRIPTION OF SOME EMBODIMENTS

Examples of a method, apparatus, and computer program are disclosed for secure revocable location sharing. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

As used herein, the term location refers to geospatial location data, unless otherwise evident from the context. A subscriber refers to an entity or person who has registered with a network subscription service to receive a service based on information provided to the service by the subscriber. The information provided by the subscriber is stored by the subscription service in one or more subscriber profiles data structures. Although various embodiments are described with respect to sharing a subscriber's current location, it is contemplated that the approach described herein may be used with other locations associated with a subscriber, such as an office, home, school, place of worship, or other location regardless of the subscriber's current location.

As used herein a cipher refers to a value that contains a message in hidden form. In the illustrated embodiments, the message is a subscriber's location. The process of the changing the message to the cipher is called enciphering. When the message is a location, the cipher can be called a ciphered location. The process of changing the cipher back to the message is called deciphering. A location recovered from a ciphered location is therefore often called a deciphered location. The terms encrypt and decrypt are often used in the art as synonyms for encipher and decipher, respectively. Because a crypt also refers to an enclosure for a dead body, the forms encipher and decipher are preferred and used herein.

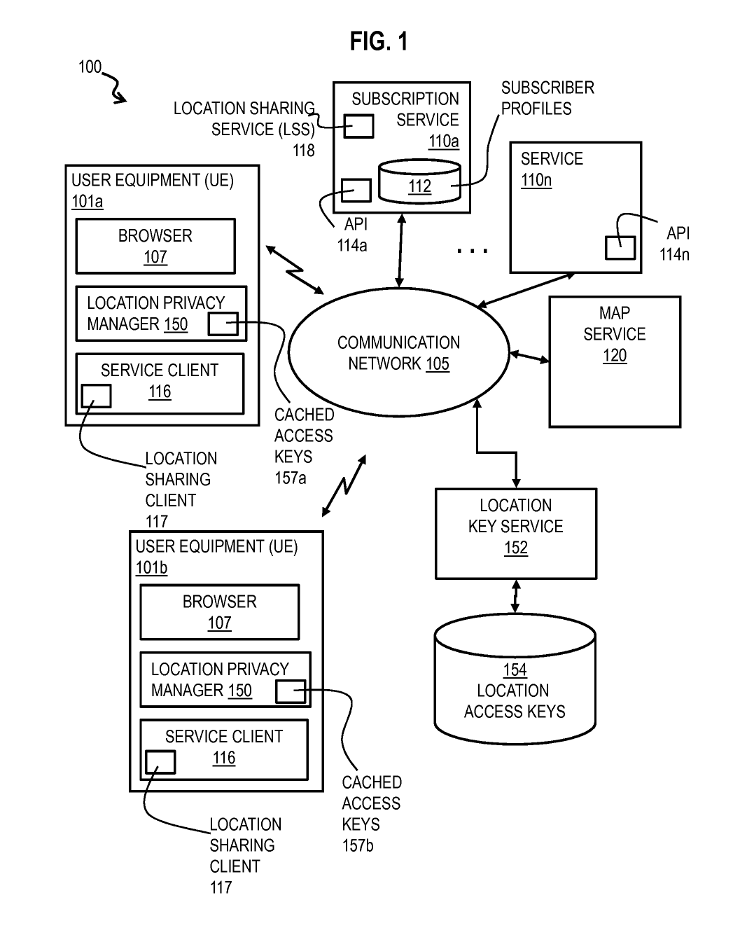

FIG. 1 is a diagram of a system capable of secure revocable location sharing, according to one embodiment. The general architecture of a location-sharing service (LSS) includes a LSS 118 on subscription service 110a which is accessed by a subscriber with a browser process 107 or service client process 116 on user equipment (UE), e.g., UE 101a. Backend functions of the subscription service 110a can be reached through an application programming interface (API) 114a. A subscriber Alice, operating user equipment (UE) 101a designates subscriber Bob, operating UE 101b, as a “friend,” and this information is stored in a subscriber profiles data structure 112 for both Alice and Bob. A location sharing client 117 on Alice's UE 101a submits her location to the LSS 118 which stores the location in the subscriber profiles data structure 112. A location sharing client 117 on Bob's UE 101b makes a request to the LSS 118 to retrieve the locations of all his “friends”. The LSS 118 checks the subscriber profiles data structure 112 to determine that Alice is a friend of Bob. The LSS 118 sends Alice's location to the location sharing client 117 on Bob's UE 101b. As a result, the LSS 118 and subscriptions service 110a are fully aware of Alice's location information, exposing her location to anyone who misuses the subscription service 110a or the API 114a. Furthermore, subscribers who make use of more than one of these network services 110a through 110n simultaneously increase the chances that they will suffer from a loss of privacy.

To address this problem, a system 100 of FIG. 1 introduces a location privacy manager module 150 and a location key service 152 separate from the LSS 118. Therefore, the location key service 152 is different from the location sharing network service LSS 118. The location privacy manager module 150 enciphers Alice's location using a key stored at the location key service 152 before sending the ciphered location to the LSS 118. The ciphered location is stored in the subscriber profiles data structure 112, but neither the LSS 118 nor the subscription service 110a has the key. That is, the access key is not associated with a first identifier for the subscriber at the location sharing network service. The LSS 118 sends Alice's ciphered location to Bob's UE 101b. The location privacy manager module 150 on Bob's UE 101b requests Alice's key from the location key service 152 and uses that key to decipher Alice's location and pass the deciphered location to the location sharing client 117 on Bob/s UE 101b. The location key service 152 stores, in location access keys data structure 154, data indicating Alice's identity and data indicating her location access key and data indicating a list of subscribers, such as Bob, who are privileged to obtain the key to decipher her location. Alice can tailor the list of those who have access to her location to differ from the complete friends list known to the subscription service 110a. Alice can revoke privileges by changing the key and removing the subscriber's identifier from the list in data structure 154. For example, Alice can stop sharing her location with Bob by removing an identifier for Bob from the location access keys data structure 154 and changing the value of her access key.

Using the separate location key service 152 is an advantage because when Alice's key is changed, her UE 101a only communicates the change to the location key service 152 and not to every privileged friend. Only when a privileged friend asks for Alice's location does the UE of that privileged friend request the key from the location key service 152. Bandwidth is saved on a communications network 105 and computational resources are saved on a host of the location key service 152 because the key change is passed on demand and not pushed to every privileged user with every key change.

In some embodiments, if the same entity controls, or has access to, both the subscription service 110a and location key service 152, the key can still be kept secure by using different identifiers for Alice on the key service 152 than on the subscription service 110a, as described in more detail below. In an invitation message, Alice informs the privileged subscribers of her different identifier at the location key service to be used for multiple key changes. Thereafter the location key service 152 propagates key changes to the privileged users on demand.

As shown in FIG. 1, the system 100 comprises user equipment (UE) 101a and UE 101b (collectively referenced hereinafter as UE 101) having connectivity to one or more network services including map service 120, subscription service 110a through network service 110n (collectively referenced hereinafter as network services 110) as well as a location key service 152, via a communication network 105. By way of example, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The network services 110 include one or more with API, such as API 114a in subscription service 110a and API 114n in network service 110n. The subscription service 110a includes subscriber profiles data structure 112 and a location sharing service (LSS) 118, as described above.

The location key service 152 maintains the location access keys data structure 154 and distributes location access keys of one or more subscribers to one or more privileged contacts of each subscriber. The location key service 152 thus manages the location access keys for a subscriber. A subscriber creates a location access key at the location key service 152 to enable “friends” to decipher the user's location. The location key service 152 is preferably a separate entity from the location-sharing service (e.g., LSS 118), e.g., they are not under the control of the same organization.

The UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, Personal Digital Assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

By way of example, the UE 101, network services 110 and location key service 152 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, often higher layer of the OSI Reference Model. The header for a particular protocol typically indicates a type for the next protocol contained in its payload. The payload protocol is said to be encapsulated in the header protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

Processes executing on various devices, often communicate using the client-server model of network communications, widely known and used. According to the client-server model, a client process sends a message including a request to a server process, and the server process responds by providing a service. The server process may also return a message with a response to the client process. Often the client process and server process execute on different computer devices, called hosts, and communicate via a network using one or more protocols for network communications. The term “server” is conventionally used to refer to the process that provides the service, or the host on which the process operates. Similarly, the term “client” is conventionally used to refer to the process that makes the request, or the host on which the process operates. As used herein, the terms “client” and “server” refer to the processes, rather than the hosts, unless otherwise clear from the context. In addition, the process performed by a server can be broken up to run as multiple processes on multiple hosts (sometimes called tiers) for reasons that include reliability, scalability, and redundancy, among others. A well known client process available on most devices (called nodes) connected to a communications network is a World Wide Web client (called a “web browser,” or simply “browser”) that interacts through messages formatted according to the hypertext transfer protocol (HTTP) with any of a large number of servers called World Wide Web (WWW) servers that provide web pages.

In the illustrated embodiment, the UE 101 include a browser 107, a service client 116 for one or more of the network services 110, and a location privacy manager module 150. In some embodiments, one or more of services 110 interact with a user of UE 101 though a browser 107, and the service client 116 is a script or form within the browser 107. In some embodiments, a separate service client 116 employs the graphics and forms of the browser 107 as a user interface for prompting and detecting user input at UE 101. The service client 116 includes a location sharing client 117 that interacts across communications network 105 with the LSS 118.

According to the illustrated embodiment, the location privacy manager module 150 exchanges actual locations with the location sharing client 117 and exchanges only ciphered locations with the LSS 118. In the illustrated embodiment, the location privacy manager module 150 on UE 101a and 101b also caches access keys already exchanged with the location key service 152 in cached access keys data structures 157a and 157b, respectively (collectively referenced hereinafter as cached access keys data structure 157). In some embodiments, cached access keys data structure 157 is omitted on one or more UE 101. Thus, location privacy manager module 150 is the layer through which subscribers access a location-sharing service (LSS) or the location key service 152. When a subscriber initiates a location upload to the LSS 118, the location privacy manager module 150 performs the appropriate actions to protect the subscriber's privacy by enciphering the subscriber's location with a key equal or related to the subscriber's location access key, and by sending the ciphered location to the LSS 118. Thus, enciphering and deciphering are performed locally on the user's device UE 101. That is, a user's location is enciphered on the user's device (UE 101) before upload and “friends” locations are deciphered on the user's device (UE 101) for viewing. Hence the locations of any subscriber cannot be viewed in their clear (deciphered) form outside of the user's device (UE 101).

Although processes and data structures are shown in FIG. 1 as integral blocks in a particular order on particular nodes of the communication network for purposes of illustration, in other embodiments, one or more processes or data structure or portions thereof are arranged in a different order on the same, more or fewer nodes of the network or in one or more databases or are omitted or one or more additional processes or data structures are included.

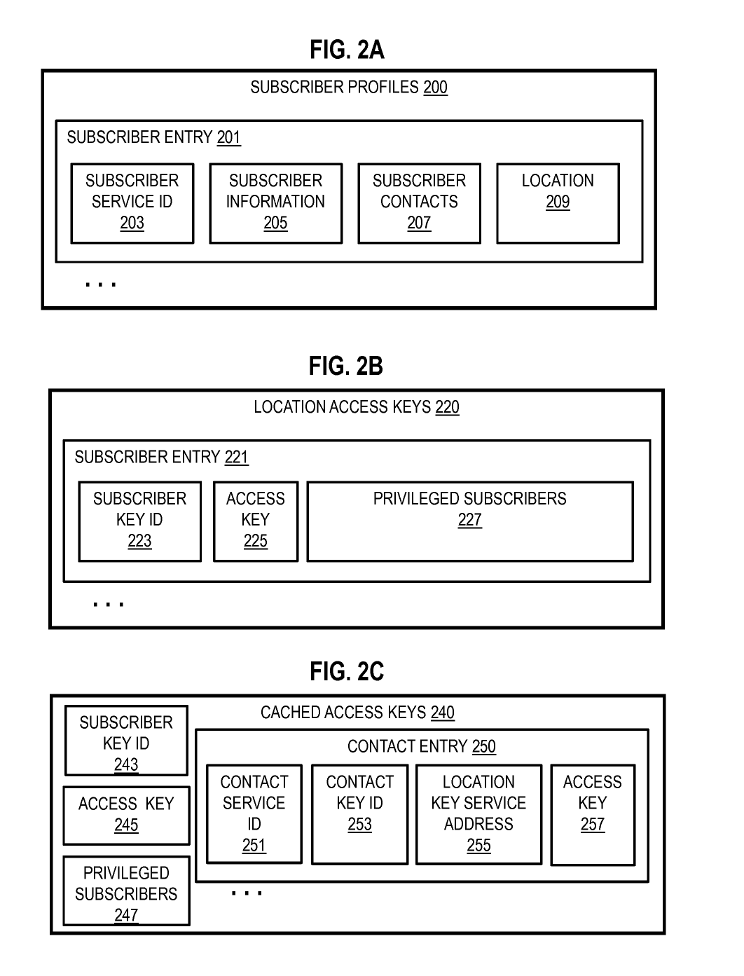

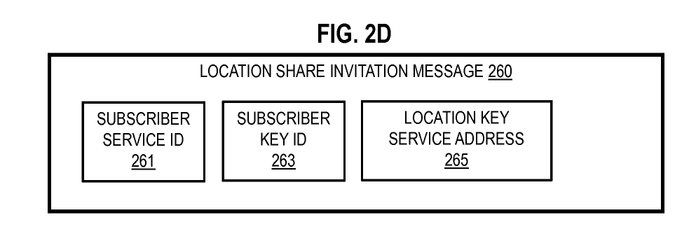

FIG. 2A is a diagram of a subscriber profiles data structure 200, according to one embodiment. Data structure 200 is a particular embodiment of subscriber profiles data structure 112 depicted in FIG. 1. Although fields, entries and data structures are depicted in FIG. 2A through FIG. 2D as integral blocks in a particular arrangement for purposes of illustration, in other embodiments, one or more fields, entries, data structures, or portions thereof, are arranged in a different order or in one or more databases on one or more nodes of the communications network, or are omitted, or one or more additional fields, entries or data structures are included.

The subscriber profiles data structure 200 includes a subscriber entry field 201 for each of one or more subscribers as indicated by ellipsis. Each subscriber entry field 201 includes a subscriber service identifier (ID) field 203, a subscriber information field 205, a subscriber contacts field 207, and a location field 209.

The subscriber service ID field 203 holds data that indicates an identifier for the subscriber at the subscription service. For example, at a social networking service, Alice is identified as “Alice123” and data indicating “Alice123” is stored in field 203. Alice may have other identifiers at other subscriber services, such as Alice567” or “AllyZ”. Furthermore, in some embodiments, Alice may use a different identifier at the location key service 152, as described in more detail below. The subscriber's identifier at the location key service is called the key identifier (ID) and the subscriber's identifier at the location sharing service (LSS 118) or subscription service 110a is called the service identifier (ID), hereinafter. Thus the service ID in field 203 is used to refer to an identifier for Alice at subscription service 110a.

The subscriber information field 205 holds data that indicates information about the subscriber, such as actual name, birth date, gender, relationship status, city and province and country of residence, an email address, a telephone number, a postal address, and billing information, if any, among others.

The subscriber contacts field 207 holds data that indicates one or more contacts of the subscriber within the subscription service, e.g., the service IDs of other subscribers with whom the subscriber has established a relationship. In some embodiments in which different relationships are supported, e.g., family, close friends, acquaintances, the relationship is included with the service ID of each contact of the subscriber.

The location field 209 holds data that indicates one or more locations of the subscriber, such as the most recent location or the location of home or work or school or place of worship or other context sensitive location. The information in the location field 209 is shared with one or more other subscribers, such as one or more subscriber contacts indicated in field 207, through the LSS 118. According to various embodiments, the location field 209 holds data that indicates only ciphers of the one or more locations, so that the subscription service 110a and LSS 118 are unable to determine the actual location or locations associated with the subscriber. Storing ciphers of the location in field 209 is an example means to achieve the advantage of protecting the privacy of the subscriber's location information from the subscription service or other users thereof, without express privilege from the subscriber.

The subscriber contact who receives the location data from field 209 should decipher the data using an access key for the subscriber indicated in the subscriber service ID field 203. That access key is maintained separately by the location key service 152. Maintaining access keys at a separate service is an example means to achieve the advantage of protecting the privacy of the subscriber's location information from the subscription service or other users thereof, without express privilege from the subscriber.

Some LSS 118 associate the subscriber's location with one or more related items as determined, for example, by the map service 120 or other network service 110. When the location field 209 contains only a cipher of the subscriber's location, the LSS 118 and subscription service 110a are unable to promote items related to the subscriber's spatial context. A technique to resurrect this capability, at least temporarily, in some embodiments is described in more detail below.

FIG. 2B is a diagram of a location access keys data structure 220, according to one embodiment. Data structure 220 is a particular embodiment of location access keys data structure 154 depicted in FIG. 1. The location access keys data structure 220 includes a subscriber entry field 221 for each of one or more subscribers as indicated by ellipsis. Each subscriber entry field 221 includes a subscriber key identifier (ID) field 223, an access key field 225, and a privileged subscribers field 227.

The subscriber key ID field 223 holds data that indicates an identifier for the subscriber at the location key service 152. In some embodiments, the same value, e.g., “Alice123,” is used for both the service ID and key ID. However, in some embodiments, the same entity controls, or has access to, both the subscription service 110a and the location key service 152, e.g., through one or more API. To prevent such an indirect disclosure of the subscriber's access key to the LSS 118 or subscriptions service 110a, in some embodiments the subscriber uses a different value in the key ID field 223. For example, Alice uses “LookingGlassXYZ” as the key ID indicated by data stored in the subscriber key ID field 223.

The access key field 225 holds data that indicates a secret key used to decipher a cipher of a location associated with the subscriber identified in key ID field 223. Any secret key may be used that deciphers a location from a cipher of the location. For example, in some embodiments, the secret key is a symmetric key that is used to both encipher a message and decipher it. Several algorithms using symmetric keys are well known, such as a N-bit key used in an exclusive logical OR (XOR) binary operation on N bits at a time, or an N-bit key used in a Data Encryption Standard (DES) algorithm. In some embodiments, the secret key is used just for deciphering; and a different key, known to the subscriber identified in field 223, is used to generate a ciphered message, e.g., a ciphered location. In such cases the enciphering key is associated with the access key at least at the location privacy manager module 150. An advantage of the symmetric key is that only one key needs to be saved by the subscriber. An advantage of a non-symmetric key is that only the subscriber can encipher the locations, even though all the privileged contacts can decipher the locations.

The privileged subscribers field 227 holds data that indicates one or more contacts of the subscriber who are allowed to receive the access key. In some embodiments, the privileged subscribers are indicated by a list of their servicer IDs. For example, if Bob subscribes to the subscription service as “Bob456” and Bob is to be granted the privilege of accessing Alice's location, then data indicating “Bob456” is included in the privileged subscribers field 227. Thus the field 227 holds data used to determine who is permitted to “view” a given subscriber's locations. When subscriber A accepts a “friend” request from another subscriber B via the LSS 118, the location privacy manager module 150 issues a corresponding update message that indicates “add subscriber B to subscriber A's privileged subscribers list” to the location key service 152. Subscriber B is thus allowed to retrieve subscriber A's location access key from the location key service 152. This enables subscriber B to “view” subscriber A's locations on subscriber B's local device.

FIG. 2C is a diagram of a cached access keys data structure 240, according to one embodiment. Data structure 240 is a particular embodiment of cached access keys data structure 157 maintained on the UE 101, as depicted in FIG. 1. The cached access keys data structure 240 includes a subscriber key identifier (ID) field 243, a subscriber access key 245, a privileged subscribers field 247, and a contact entry field 250 for each of one or more contacts of the subscriber, as indicated by ellipsis. Each contact entry field 250 includes a contact service identifier (ID) field 251, a contact key identifier (ID) field 253, a location key service address field 255, and an access key field 257.

The subscriber key ID field 243 holds data that indicates the identifier for the subscriber in the location access keys data structure 220 of the location key service 152. In some embodiments, if the subscriber's service ID is also used at the location key service, field 243 is omitted.

The access key field 245 holds data that indicates the access key stored in the location access keys data structure 220 at the location key service 152. In some embodiments that use an asymmetric key, i.e., a different key to turn the location into a cipher (encipher) than is used to turn the cipher into the location (decipher), the access key field 245 also includes data that indicates the key used to encipher the location.

The privileged subscribers ID field 247 holds data that indicates the service identifiers for the subscribers who are allowed to share the location of the subscriber indicated in field 243.

The contact service ID field 251 holds data that indicates an identifier for the contact at the subscription service 110a or LSS 118. The contact key ID field 253 holds data that indicates an identifier for the contact at the location key service 152. If the same value is used for both a service ID and a key ID, then in some embodiments one of field 251 or 253 is omitted and the other indicates both the service ID and the key ID of the contact.

The location key service address field 255 holds data that indicates the network address of the location key service 152, e.g., the universal resource locator (URL) name. In some embodiments that use a single location key service 152 for all subscribers to the subscription service 110a, field 255 is omitted.

The access key field 257 holds data that indicates the access key, if any, last retrieved from the location key service 152 for the contact identified in field 251 and 253. The access key field 257 is an example means to achieve the advantage of reducing message traffic over the communications network and computational resources at the host of the location key service if a previously retrieved access key still suffices to decipher the locations of the contact.

FIG. 2D is a diagram of a location share invitation message 260, according to one embodiment. As described in more detail below, the message 260 is sent from a subscriber to one or more contacts to invite the one or more contacts to decipher the subscriber's locations. Because the message 260 sends only a notice that the subscriber will share the location but not the access key, the message is sent only once no matter how often the access key is changed. This saves computational resources on the UE. The use of the separate location key service is an example means to achieve the advantage of saving these computational resources on the UE. In some embodiments that use only one location key service 152 and that use the same value for both the service ID and the key ID, the invitation message 260 is omitted. The location share invitation message 260 includes a subscriber service identifier (ID) field 261, a subscriber key identifier (ID) field 263 and a location key service address field 265.

The subscriber service ID field 261 holds data that indicates an identifier for the subscriber at the subscription service 110a or LSS 118. The subscriber key ID field 263 holds data that indicates an identifier for the subscriber at the location key service 152. If the same identifier is used for both, then in some embodiments one of field 261 or 263 is omitted and the other indicates both the service ID and the key ID of the subscriber.

The location key service address field 265 holds data that indicates the network address of the location key service 152, e.g., the universal resource locator (URL) name. In some embodiments that use a single location key service for all subscribers to the subscription service 110a, field 265 is omitted.

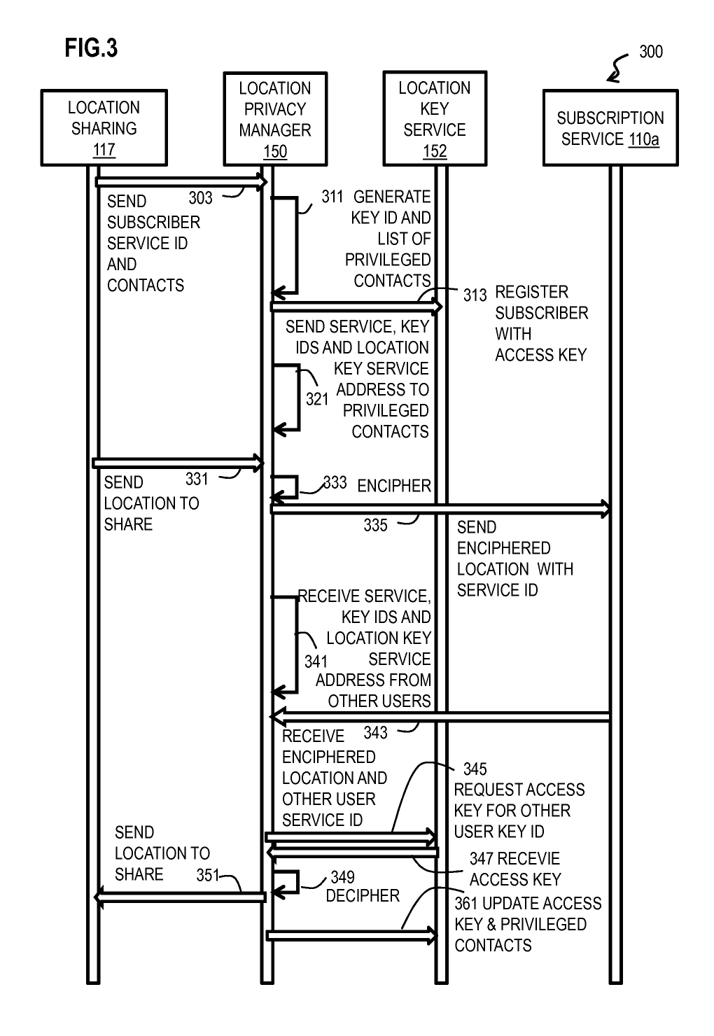

FIG. 3 is a time sequence diagram 300 of messages exchanged to provide secure revocable location sharing, according to an embodiment. In FIG. 3 time increases downward (not to scale), an individual network process is represented by vertically elongated boxes labeled by rectangles at the top. A message sent from one process to another is indicated by a horizontal arrow pointing from the sending process to the receiving process. A step at a single process is indicated by a segmented arrow looping back on the process at a vertical position indicative of the relative time when the step occurs. The processes represented in FIG. 3 include the location sharing client 117, the location privacy manager module 150, the location key service 152, and the subscription service 110a (including LSS 118).

In one or more messages 303, the location sharing client 117 of the service client 116 sends the subscriber service ID and contacts to the location privacy manager module 150 on the UE 101. In this manner the privacy manager module 150 determines the subscriber ID for the user of UE 101 and the contacts from which to select the contacts privileged to share locations with the subscriber.

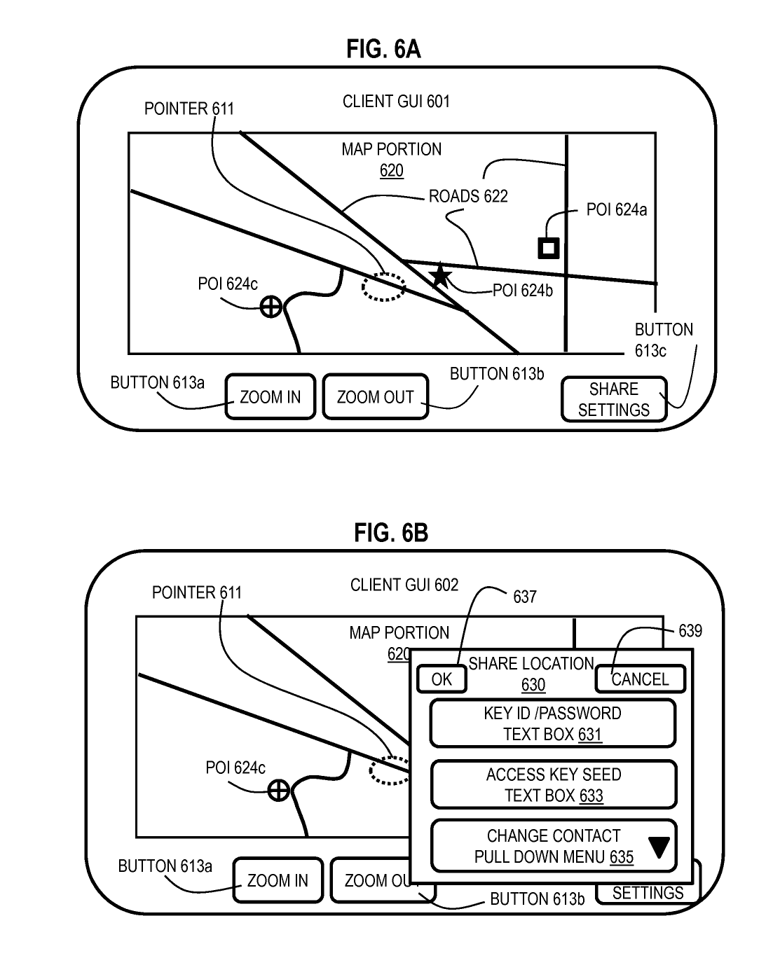

In step 311 the location privacy manager module 150 generates a key ID for the subscriber to use at the location key service and a list of privileged contacts. For example, the user of UE 101 is prompted to provide a key ID and to select one or more privileged contacts from the list of contacts provided by the subscription service through the service client 116 and location sharing client 117. For example, a share location graphical user interface is presented on a display of the UE 101 as described below with reference to FIG. 6B. The contacts can be indicated in any manner. In the illustrated embodiment, the contacts are indicated by their service identifiers, as stored in subscriber profiles 112. In some embodiments that use the same value for both service ID and key ID, the generation of the key ID is trivial and no prompt is presented on UE 101 to the subscriber.

In one or more update messages 313, the subscriber is registered with the location key service 152 and associated with an access key for deciphering enciphered locations. In some embodiments, the location key service 152 generates the key. In some embodiments, the location privacy manager module 150 generates the key. In some embodiments, the key is generated based, at least in part, on a seed value provided by the user of UE 101, e.g., in response to a prompt presented in a graphical user interface as described below with reference to FIG. 6B. The list of privileged contacts is also provided in the one or more update messages 313. The location key service 152 stores the key and list of privileged contacts in association with the subscriber's key ID, e.g., in subscriber entry field 221 of the location access keys data structure 220. During registration, in some embodiments, the subscriber is also prompted to present credentials (such as a password) to be used to authenticate the subscriber in subsequent messages to the location key service 152. In some embodiments the access key is generated by the location key service 152 and returned to the location privacy manager module 150 in one or more messages, not shown.

In step 321, one or more location share invitation messages 260 are sent to the location privacy manager modules on the UE 101 of the privileged contacts, either directly, or indirectly through the LSS 118 or subscription service 110a. In some embodiments in which the service ID and the key ID are identical and the location key service network address is known by all subscribers, step 321 is omitted.

In one or more messages 331, the location sharing client 117 sends a location to share, e.g., based on the current location of the UE 101 as determined from a global positioning system (GPS) or based on user input indicating a location to be associated with the subscriber. In prior approaches, messages 331 would be directed to the LSS 118 in the subscriptions service 110a. However, according to the illustrated embodiment, the message goes to the location privacy manager module 150 to encipher the location in step 333. In one or more messages 335, the cipher with the subscriber's service ID is sent to the LSS 118 of the subscription service 110a to share with other contacts.

In step 341, one or more location share invitation messages 260 are received from the location privacy manager modules on the UE 101 of one or more contacts of the subscriber, either directly, or indirectly through the LSS 118 or subscription service 110a. Each message indicates the subscriber is privileged to decipher the locations of the sending contact. In some embodiments in which the service ID and the key ID are identical and the location key service network address is known by all subscribers, step 341 is omitted.

In one or more messages 343, the LSS 118 of the subscription service 110a sends a cipher of a location to share, e.g., based on the current location of the UE of a contact as determined from a global positioning system (GPS) or based on user input indicating a location to be associated with the contact. The contact is identified by the contact's service ID. In prior approaches, messages 343 would be directed to the location sharing client 117 in the service client 116. However, according to the illustrated embodiment, the message goes to the location privacy manager module 150 to decipher the location.

If the access key for the contact is already cached in data structure 157, the cipher for the location is deciphered using the cached key to provide the actual location. If the key is not cached, or if the deciphered location is faulty, then the location privacy manager module 150 sends a request message 345 to the location key service for the access key for the contact. The ID for the contact at the location key service (e.g., the key ID) and the service ID of the requesting subscriber are used in the request message 345. In some embodiments, the service credentials of the requestor are also included in the one or more request messages 345.

The location key service determines whether the subscriber is included in the list of privileged contacts associated with the contact. In some embodiments, the location key service 152 also authenticates the requesting subscriber based on the credentials. If the subscriber is authenticated and privileged to share the contact's location, then one or more messages 347 are sent with the access key for the contact. In some embodiments, the request messages 345 and response messages 347 are encapsulated using a network security protocol such as HTTP secure (HTTPS). The contact's key ID and access key are cached in cached access keys data structure 157 on the local UE 101 by the location privacy manager module 150.

In step 349, the location privacy manager module 150 deciphers the cipher for the location and provides the actual location to be shared. In one or more messages 351, the deciphered location is sent to the location sharing client 117 of the service client 116 to share with the subscriber, e.g., by plotting contact locations on a graphic depicting a map.

At some later time, in one or more messages 361, the access key of the subscriber and the list of privileged contacts is updated. During the update in some embodiments, a new contact can be granted the privilege, which does not require a change of the access key. In some of these embodiments, an invitation message 260 is sent to each of the added contacts. During updates in some embodiments, a former privileged client is removed which should involve a change of the access key. No new invitation messages 260 are sent when a contact is removed. When the remaining privileged contacts attempt to decipher an enciphered location of the subscriber, any cached access key should fail and a request message 345 should be sent by the location privacy manager module 150 on the contact's UE (e.g., Bob's UE 101b) to the location key service 152 to obtain the new access key. By updating the location key service 152 instead of all the subscriber's contacts, the system 100 scales well for subscribers with many contacts. The location key service 152 just send the new access key to the contacts who send a request, thus saving computational resources and bandwidth updating contacts who are not attempting to share the subscriber's location. The separate location key service 152 is an example means to achieve the advantage of these reductions in the consumption of computational resources and bandwidth.

The system 100 ensures that a mobile user's location privacy is protected while taking part in location-sharing services. The system 100 makes no assumption of trust. A goal of the system 100 is to ensure that no external party is allowed to “view” the user's locations. Only those that have been authorized by a user can “view” the user's location. So while a location sharing service may serve as the location data management system, where users constantly “upload” their current location information such as GPS information and where users retrieve location information of their “friends”, the system 100 prevents the location data management system (e.g., LSS 118 and subscription service 110a) from gaining any knowledge of the subscribers' actual locations.

In some embodiments, the subscriber may allow the LSS provider to decipher the subscriber's location. For example, providers can use subscribers' locations to supply other services such as location-based advertising that involve knowledge of the subscribers' locations. A subscriber may designate a LSS provider as a “contact” and include the provider in the list of privileged contacts in field 227 on the location key service 152. The privilege can be revoked at any time using the same procedure described above for revoking the privilege of any other contact, e.g., by removing the contact from field 227 and changing the access key in field 225.

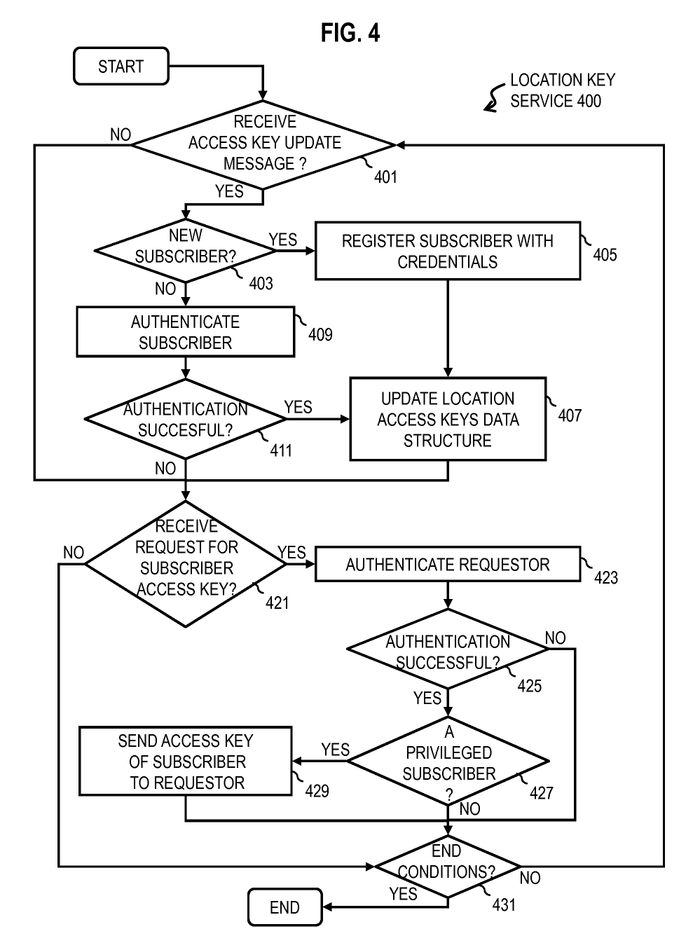

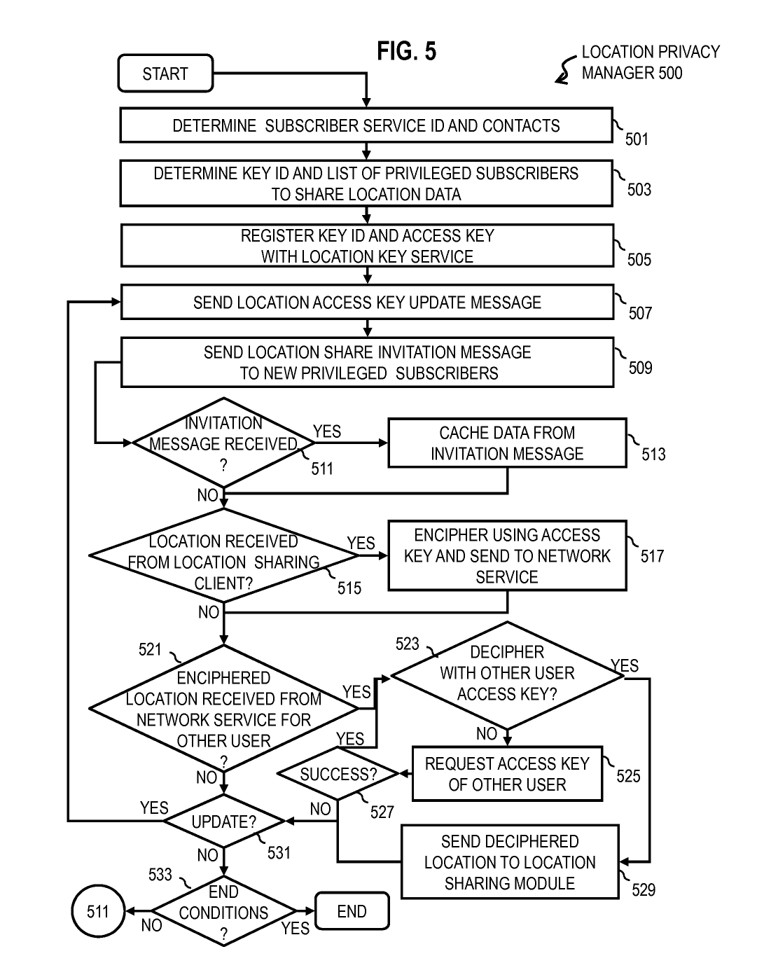

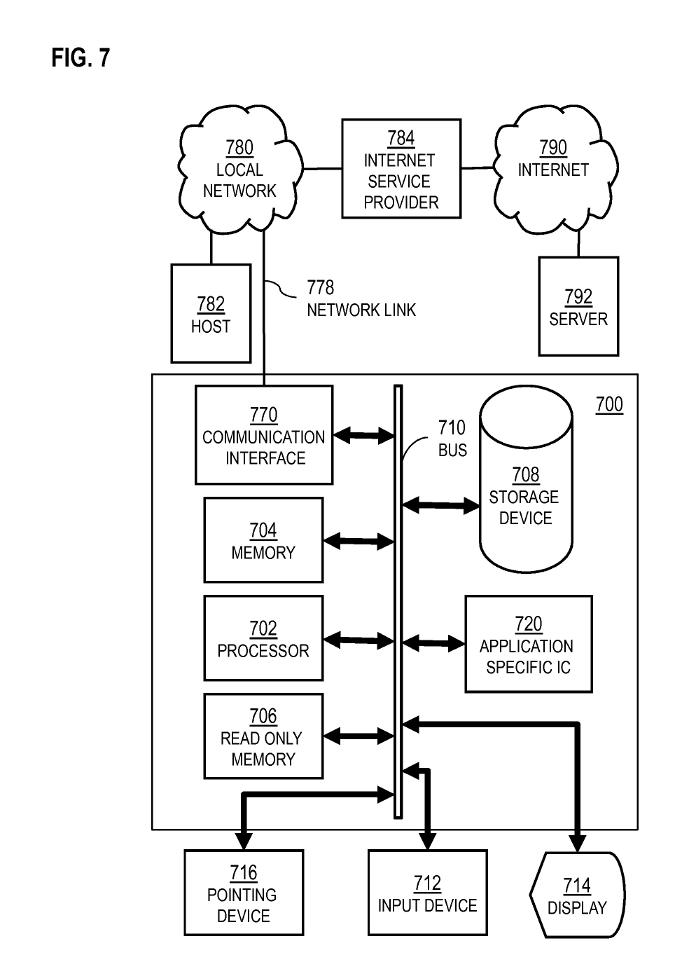

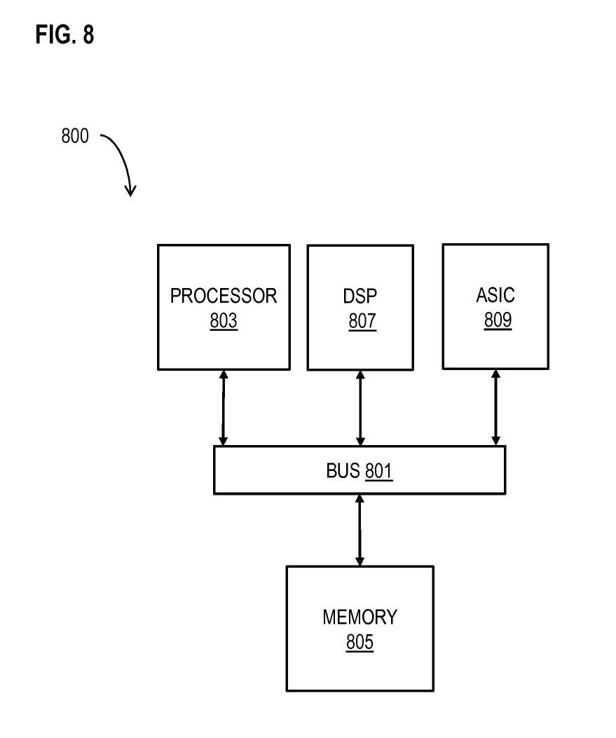

FIG. 4 is a flowchart of a process 400 for location key service, according to one embodiment. In one embodiment, the location key service 152 performs the process 400 and is implemented in, for instance, a chip set including a processor and a memory as shown in FIG. 8 or general purpose computer 700 as depicted in FIG. 7. Although steps are depicted in FIG. 4 and FIG. 5 as integral blocks in a particular order for purposes of illustration, in other embodiments one or more steps or portions thereof are performed in a different order, or overlapping in time, in series or in parallel, or are omitted or one or more steps are added, or the process is changed in some combination of ways.

In step 401, it is determined whether an access key update message is received. For example, one or more messages are received at the location key service with one or more fields to be stored in a subscriber entry field 221 of the location access keys data structure 220. For example, one or more messages are received from Alice's UE 101a that indicate a subscriber “LookingGlassXYZ”, and a list of one or more privileged subscribers including “Bob456.” If not, control passes to step 421 described below.

If it is determined, in step 401 that an access key update message is received, then in step 403 it is determined whether the update message indicates a new subscriber. For example, it is determined whether the subscriber ID in the update message (e.g., “LookingGlassXYZ”) is different from any subscriber ID in field 223 of any entry field 221 in the data structure 220. If so, then the update message is treated as a registration message 313; and in step 405 the new subscriber is registered. In some embodiments the access key update message is also enciphered, e.g., using the HTTPS protocol.

Step 405 to register a new subscriber includes adding a new subscriber entry field 221 to the location access keys data structure 220 based on the update message. Data indicating the subscriber ID is stored in field 223. The subscriber ID is the key ID for the subscriber, which is used as the subscriber ID at the location key service 152. In some embodiments, the key ID for the subscriber is the same as the service ID for the subscriber at the LSS 118 or subscription service 110a. For example, in some embodiments, the subscriber key ID in the update message is the same as the service ID “Alice123” instead of the different key ID “LookingGlassXYZ.”

An access key is also determined during step 405, either based on a value sent in the update message or by the location key service 152. Any method to generate a secret key may be used to determine the access key, such as using a key exchange protocol, hashing an arbitrary seed string provided by the subscriber, or using a random number generator or selecting the next value in a sequence of random numbers stored in a data structure (not shown) at the location key service, among others, or some combination.

An initial list of privileged subscribers is also determined during step 405 and data indicating the list is stored in field 227. Any method may be used to determine the initial list. For example, in some embodiments, the list is included in the one or more update messages sent by the new subscriber. In embodiments that use different subscriber IDs for the subscriber key ID at the location key service 152, the privileged subscribers IDs in field 227 indicate the contacts' service IDs, because the request for location access keys will be associated with the requestor's service ID. For example the update message from Alice's UE 101a that indicates a subscriber key ID of “LookingGlassXYZ” specifically lists “Bob456”, which is Bob's service ID.

In some embodiments that use the same value for the subscriber key ID as in the subscriber service ID, the initial list is requested from subscription service 110a based on the contents of the subscriber contacts field 207 in the subscriber entry field 201 for the subscriber service ID field 203 that matches the subscriber key ID field 223. For example, in embodiments that use the same ID, the update message from Alice's UE 101a indicates the subscriber is “Alice123.” The location key service 152 then requests from the subscriptions service 110a, e.g., using API 114a, the contact list in field 207 of the subscriber entry field 201 that indicates “Alice123” in field 203.

In some embodiments, step 405 includes determining one or more credentials to authenticate the new subscriber in future messages, such as a password or answer to a security question with or without a text recognition test to rule out machine attempts, or some combination. Control then passes to step 407, described below to update the location access keys data structure, e.g., data structure 220.

If it is determined, in step 403 that the update message does not indicate a new subscriber, then in step 409 the subscriber is authenticated to indicate that the update message is from the same person who registered the subscriber ID. For example, a password is demanded and checked against the credentials obtained during step 405. In step 411, it is determined whether the authentication is successful. If so, then in step 407 the location access keys data structure 154 is updated, as described next. If not, control passes to step 421.

In step 407, the location access keys data structure 154, e.g., data structure 220, is updated based on the one or more update messages. For example, a new subscriber entry field 221 is added based on a registration update message 313, and an existing subscriber entry field 221 is modified based on other update messages, e.g., 361. During the update, the access key may be changed or one or more privileged subscribers may be added to or deleted from the privileged subscribers field 227, or some combination, based on the update message. Thus, step 407 includes determining to associate a first (key) identifier for a subscriber with an access key and at least one second (service) identifier at a location sharing network service for a contact of the subscriber.

In step 421, it is determined whether a request message is received for the access key of a subscriber. A request message, e.g., request message 345, includes data that indicates the requestor using the requestor's service ID. The request message also indicates a subscriber's key ID. Thus, step 421 includes receiving a request message for the access key, wherein the request message indicates the first identifier at the location key service, i.e., the key ID. For example, a request message 345 is received from the location privacy manager module 150 on Bob's UE 101b. The request message indicates the requestor is “Bob456” for the access code of “LookingGlassXYZ.” In some embodiments, the request message also includes a code that indicates the message is a request message. Any protocol may be used to send the request message. In some embodiments, a request message includes one or more credentials for authenticating the requestor. If a request message is not received, then control passes to step 431. In step 431, it is determined whether end conditions are satisfied, e.g., to shut down or replace the location key service 152. If so, the process ends. Otherwise, the process continues with step 401 described above.

If it is determined, in step 421, that a request message is received for the access key of a subscriber, then in step 423, the requestor is authenticated. Any method may be used to authenticate the requestor. For example, in some embodiments, the request message includes one or more credentials for the requestor as used at the LSS 118 or subscription service 110a. In some of these embodiments, during step 423, the requestor ID and one or more credentials are sent to the subscription service 110a, e.g., using API 114a. For example, the requestor ID “Bob456” and credentials are sent to the subscription service 110a to authenticate Bob. A response message is received from the subscription service 110a. The response message indicates success or failure of the authentication.

In step 425, it is determined whether the requestor was successfully authenticated. If not, control passes to step 431 to determine if end conditions are satisfied, as described above.

If it is determined, in step 425, that the requestor was successfully authenticated, then in step 427 it is determined whether the requestor is a privileged subscriber for the access key of the other subscriber based on the service IDs in field 227. Thus, step 427 includes determining whether a service identifier for a sender of the request message is included in the at least one second service identifier associated with the first key identifier. For example, it is determined whether “Bob456” is included in field 227 for “LookingGlassXYZ.” If not, control passes to step 431, described above.

If it is determined, in step 427, that the requestor is a privileged subscriber, then in step 429 the access key of the subscriber is sent to the requestor. Thus, step 429 includes determining to send the access key associated with the first key identifier in response to the request message, if the service identifier for the sender is included in the at least one second service identifier. For example, message 347 with Alice's access key from field 225 (of the subscriber entry field 221 with “LookingGlassXYZ” in subscriber key ID field 223) is sent to the location privacy manager module 150 on Bob's UE 101b. Control passes to step 431, described above.

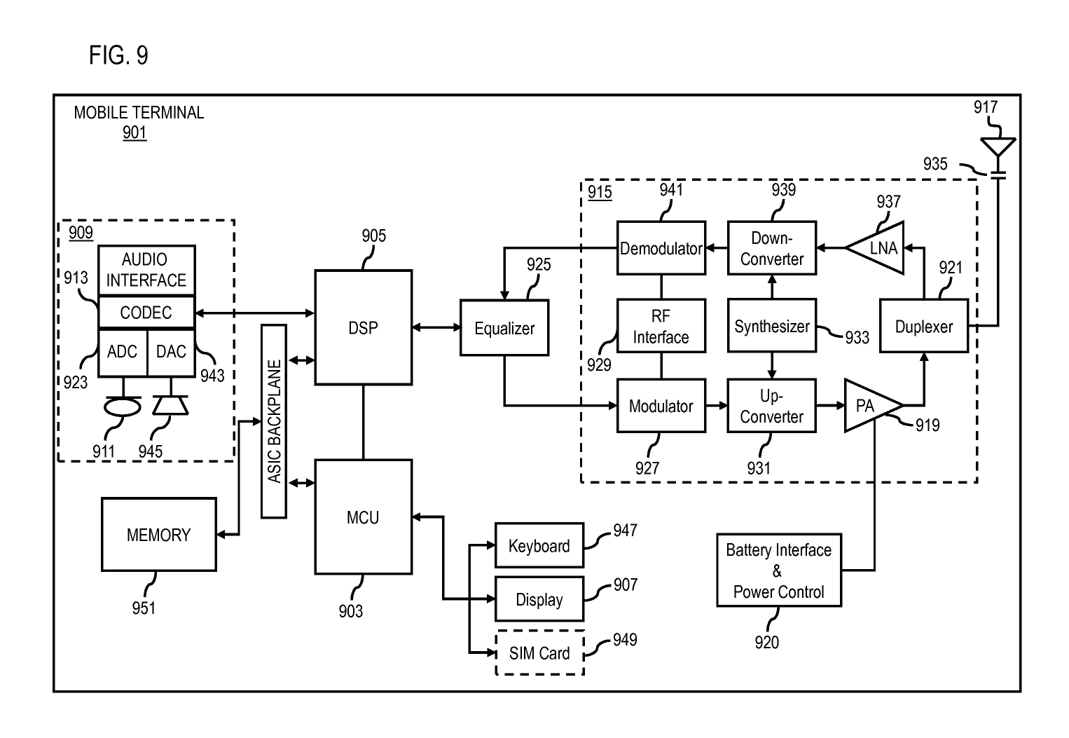

FIG. 5 is a flowchart of a process 500 for location privacy management, according to one embodiment. In one embodiment, the location privacy manager module 150 performs the process 500 and is implemented in, for instance, a chip set including a processor and a memory as shown in FIG. 8 or a mobile terminal 900 as depicted in FIG. 9.

In step 501, the subscriber service ID and contacts are determined. Any method may be used to determine these values. In various embodiments, the service ID and contacts are received from the subscription service 110a or LSS 118, either directly or indirectly through the service client 116 or location sharing client 117, e.g., in one or more messages 303. Thus method 500 includes determining a first identifier for a subscriber at a location sharing network service.

In step 503, a key ID is determined along with a list of privileged subscribers allowed to share the subscriber's location. Any method may be used to determine the key ID. In some embodiments, the key ID is the same as the service ID. In such embodiments, a second identifier for the subscriber is identical to the first identifier for the subscriber. In some embodiments, a different key ID is generated by the location privacy manager module 150 automatically. In some embodiments, the location privacy manager module 150 prompts the user of UE 101 to enter a different key ID. In both such embodiments, the second identifier for the subscriber is different from the first identifier for the subscriber.

Any method may be used to determine the list of privileged subscribers. For example, in some embodiments, the list is entered directly by the subscriber. In some embodiments, one or more privileged subscribers are selected from the list of contacts of the subscriber in the subscriber's profile as obtained from the subscription service 110a. In some embodiments, all the subscriber's contacts are automatically included in the list of privileged subscribers. In embodiments that use different service IDs and key IDs, the privileged subscribers IDs in field 227 indicate the service IDs. In some embodiments that use the same ID for the service ID and the key ID, an initial list is determined automatically by the location key service as described above. In these embodiments, during step 503, it is determined to utilize the automatic initial list from the location key service 152.

FIGS. 6A-6B are diagrams of user interfaces utilized in the processes of FIG. 5, according to various embodiments. FIG. 6A is a diagram that illustrates a client graphical user interface (GUI) 601 for a location sharing application, e.g., location sharing client 117 of service client 116 on UE 101 or browser 107 interacting with subscription 110a or map service 120, according to an embodiment. The GUI 601 includes one or more active areas in which a user selection is detected to determine user input. For example, user input is determined based on positioning a pointing device, such as a controller for a cursor and a key to indicate a selection, or a touch screen. The GUI 601 includes a map portion area 620 that presents a portion of a map, e.g., a map portion obtained from map service 120. The map portion 620 includes roads 622, points of interest (POI) 624a, 624b, 624c, among others, collectively referenced hereinafter as POI 624. A pointer 611 indicates a selected position in the map portion area 620, such as the subscriber's current position or the position of the subscriber's home, school, work or place of worship. The GUI 601 also includes buttons 613a and 613b (collectively referenced hereinafter as buttons 613) that are active areas that perform a particular function indicated by a button label upon selection by a user. For example, in response to detecting a touch on button 613a, the map portion in the map area is zoomed in to expand distances. Similarly, in response to detecting a touch on button 613b, the map portion in the map area is zoomed out to shrink distances. In the illustrated embodiment, in response to detecting a touch on button 613c, the share settings are determined.

FIG. 6B is a diagram that illustrates a client graphical user interface (GUI) 602 for inputting location sharing settings, according to an embodiment. The GUI 602 includes the map portion area 620 and buttons 613 as described above. The selected location is indicated in map portion area 620 by pointer 611. The user is prompted to input setting for sharing selected location by presenting the window 630 that includes text prompting the user to share location information. For example, in the illustrated embodiment, the text in window 630 recites the words “share your locations.” The window 630 is presented in any manner. For example, window 630 is presented by a user interface module of the location sharing client 117 or service client 116, the browser 107 or directly using the UE operating system, or some combination.

The window 630 includes a key ID and password text box 631, an access key seed text box 633 and a change contact pull down menu 635. The user of the UE 101 is prompted to add a key ID in the text box 631. In some embodiments, the text box automatically includes the service ID or an automatically generated random key ID which the subscriber can accept or over-write. For example, the text box 631 on UE 101a is presented pre-filled with “Alice123,” the service ID of the subscriber, Alice, who uses UE 101a. Alice is then able to type in a different key ID if desired; e.g., Alice types in “LookingGlassXYZ.” In some embodiments, the text box 631 includes a prompt for the user of UE 101 to enter one or more security credentials, such as a password, to be used to authenticate future messages from the subscriber. The text box 631 is an example means to achieve the advantage of indicating a key ID and password with reduced consumption of computational resources and idle time on the UE 101.

The user of the UE 101 is prompted to add a seed for the access key in the text box 633. In some embodiments, the text box automatically includes an automatically generated random access key or seed which the subscriber can accept or over-write. For example, the text box 633 on UE 101a is presented pre-filled with the date and time as a seed, e.g., “20100203141312,” Alice is then able to type in a different seed if desired. In some embodiments, the text box 633 prompts for an access key directly, instead of a seed used to generate the access key. In some embodiments, the access key is determined automatically, without input from the subscriber; and text box 633 is omitted. For example, in some embodiments, the key is obtained from a service or device, such as an electronic wallet, a radio frequency identifier (RFID) tag, secure storage, or a SIM card, among others, alone or in some combination. The text box 633 is an example means to achieve the advantage of indicating an access key with reduced consumption of computational resources and idle time on the UE 101.

The user of the UE 101 is prompted to indicate the contacts to include among the privileged subscribers for sharing the user's location by means of the change contact pull down menu 635. By selecting the pull down menu 635, the service IDs of all the subscriber's contacts from the subscriber profiles data structure 112 are listed. The user selects each one to add. In some embodiments, an option in the pull down menu is “ALL CONTACTS” to reduce time and effort in selecting all contacts. In some embodiments, an option in the pull down menu is “NO CONTACTS” to reduce time and effort to unselect all contacts. In some embodiments, an option in the pull down menu is “DELETE CONTACTS” to reduce time and effort to unselect one or more contacts already or previously added to the list of privileged subscribers. In some embodiments, the subscriber's contacts are grouped by an application, such as the social network service, (e.g., into family, work, friends, etc.) and one or more groups are included in the pull down menu. In some embodiments the contacts include contacts from the local telephone directory on the UE 101. For example, the pull down menu, when selected, lists: ALL CONTACTS; NO CONTACTS, DELETE CONTACTS; BOB456; . . . where the ellipsis indicates other contacts in field 207 from Alice's entry field 201 in the profiles data structure 200. The pull down menu 635 is an example means to achieve the advantage of indicating privileged subscribers with reduced consumption of computational resources and idle time on the UE 101.

When finished, the user of UE 101 activates the OK button 637 or the cancel button 639 to accept or reject the changes, respectively. The user choices are stored locally in the cached access keys data structure 157, e.g., in fields 243, 245 and 247 of data structure 240.

In step 505, the subscriber is registered with the location key service 152. For example, one or more update messages 313 are prepared to send to the location key service 152 with the key ID and list of privileged subscribers. In some embodiment in which the location privacy manager module 150 determines the access key, the messages 313 include the access key so determined. In some embodiment in which the location key service determines the access key, the access key is omitted from message 313 but included in a message (not shown) returned from the location key service 152 to the location privacy manager module 150. In some embodiment in which the location key service determines the access key based on a user provided seed value, the access key seed value is included in the message 313; and the access key is included in a message (not shown) returned from the location key service 152 to the location privacy manager module 150. In some embodiments, step 505 includes generating or prompting the user of UE 101 for one or more credentials, such as a password, to authenticate future messages from the subscriber. The credentials are included in the update messages prepared.

In step 507 the one or more location key access update messages, e.g., register update messages 313 or follow on update message 361, are sent from the location privacy manager module 150 to the location key service 152. In some embodiments, the update messages 313 or 361 include the subscriber's credentials. In some embodiments, a return message with the access key is returned during step 507 and stored in the access key field 245 in the cached access keys data structure 240. Thus, method 500 includes determining a location access key stored at a location key service in association with a second (key) identifier for the subscriber. Step 509 includes determining to send to the location key service a third identifier (contact service ID) indicating at least one contact of the subscriber.

In step 509, one or more location share invitation messages 260 are sent to the UE 101 of new privileged subscribers, e.g., privileged subscribers who have not yet received an invitation message. The message 260 informs the recipient of the subscriber key ID associated with the service ID, if different, and location key service address on the communications network. In some embodiments, the message 260 is sent directly to the UE 101 of the privileged subscribers, e.g., using a network address for the UE 101 of the privileged subscriber obtained from the privileged subscriber or from the subscription service 110a using API 114a. For example a location share invitation message 260 that indicates service ID “Alice123” and key ID “LookingGlassXYZ” is sent from the location privacy manager module 150 on Alice's UE 101a to the location privacy manager module 150 on Bob's UE 101b. In some embodiments, the message 260 is sent indirectly through the location sharing client 117 or service client 116. Thus, step 509 includes determining to send a location sharing invitation message to at least one contact of the subscriber, wherein the location sharing invitation message comprises data that indicates the first (service) identifier for the subscriber and the second (key) identifier for the subscriber. In some embodiments that use the same value for both the service ID and key ID only on field that indicates both is included in the invitation message. In some embodiments that use the same value for both the service ID and key ID and that use a common known location key service 152, step 509 is omitted.

In step 511, it is determined whether a location share invitation message 260 is received. For example, a location share invitation message 260 that indicates service ID “Bob456” and key ID “AndWeaveABC” is received on the location privacy manager module 150 on Alice's UE 101a, directly or indirectly, from the location privacy manager module 150 on Bob's UE 101b. If so, then in step 513 the information is cached in the local cached access keys data structure 157. For example, “Bob456” is stored in contact service ID field 251, “AndWeaveABC” is stored in contact key ID field 253 in data structure 240. The access key is not included in the invitation message and is not available for storage in the access key field 255 during step 513. Thus, step 513 includes receiving at least one location sharing invitation message indicating a corresponding contact of the subscriber, wherein the at least one location sharing invitation message comprises data that indicates a third identifier (contact service ID) for the contact at the location sharing network service and a fourth identifier (contact key ID) for the contact at the location key service.

In step 515, it is determined whether a location of the subscriber is received from the local location sharing client 117. For example, a message 331 from the location sharing client 117 is intercepted by the location privacy manager. Thus, step 515 includes receiving the at least one location associated with the subscriber from a location sharing client process different from the location sharing network service. If so, then in step 517 the location is enciphered (turned into a cipher) based on the subscriber's location access key. If the enciphering and deciphering procedures are symmetric, then the enciphering key is the same as the location access key. If not, then the enciphering key is a different value associated with the location access key, and therefore based on the chosen location access key. Thus, method 500 includes determining at least one ciphered location based on the location access key and at least one location associated with the subscriber. For example, on Alice's UE 101a, Alice's current location, received from the local location sharing client 117, is turned into a cipher using the DES algorithm and Alice's access key stored in the local cached access keys data structure 157, e.g., stored in access key field 245 of data structure 240 on UE 101a. The cipher is sent as the location to the LSS 118 in association with the subscriber's service ID, e.g., in association with Alice's service ID, “Alice123.” Thus, method 500 includes determining to send the at least one ciphered location to the location sharing network service in association with the first identifier.

Alice's contacts listed in field 207 of her entry field 201 in the subscriber profiles data structure 200 are then allowed to receive the cipher of her location, as is typical for existing location sharing services. Unlike typical sharing services, however, only her privileged subscribers can decipher her location. Similarly, Alice can only decipher locations of subscribers who have listed her as a privileged subscriber.

In step 521, it is determined whether a ciphered location of another subscriber is received from the remote location sharing service 118. For example, a message 343 from the LSS 118 of service 110a directed to the local location sharing client 117 is intercepted by the location privacy manager module 150. Thus, step 521 includes receiving, from the location sharing network service, at least one ciphered contact location associated with the third identifier. If so, then in step 523 it is determined whether the location is deciphered based on the other subscriber's location access key. The other subscriber's key ID is stored in field 253, if different from the service ID. Thus, in some embodiments, the fourth identifier for the contact is different from the third identifier for the contact. Otherwise the other subscriber's key ID is the same as the service ID associated with the cipher of the location. Thus in some embodiments, the fourth identifier for the contact is identical to the third identifier for the contact.

If the access key field 255 is empty, or the deciphered location is not in a valid range, then the location is not deciphered, and control passes to step 525 to request the access key of the other subscriber from the location key service 152, using the other subscriber's key ID.

For example, on Alice's UE 101a, a cipher associated with subscriber service ID “Bob123” is received from the remote LSS 118. It is assumed for purposes of illustration that different values are used for the service ID and the key ID. The value “Bob123” matches the value already stored in contact service ID 251; and is associated with contact key ID “AndWeaveABC.” Bob's access key is not yet stored in the associated access key field 255 of data structure 240 on UE 101a. Thus, in step 525, a request message 345 that indicates the key ID “AndWeaveABC” is sent to the location key service 152 from Alice's UE 101a. Alice indicates that she is the requestor using her service ID “Alice123” in the request message. For purposes of illustration, it is assumed that Alice's request is authenticated, e.g., by obtaining her password for the subscription service 110a in one or more prompts in a graphical user interface (not shown). The password is included in the request message. If the location key server authenticates Alice based on her password and if Alice is listed among the privileged subscribers associated with the key ID value “AndWeaveABC” in the location access keys data structure 220, then a return message 347 indicates a success and includes the access key for Bob's locations. Step 525 includes storing the access key in the cached access keys data structure, e.g., in access key field 255 associated with Bob's entry field 250. Otherwise, the return message indicates a failure. Thus step 525 includes determining to send to the location key service a request for an access key associated with the fourth identifier; and receiving a contact access key in response to sending the request.

In step 527, it is determined if the result of the request is a success. If so, then control passes back to step 523 to determine if the location is deciphered using the access key, as described above. If the location is deciphered in step 523, then in step 529 the deciphered location is sent to the local location sharing client 117 of the service client 116, e.g., to plot Bob's location on the map portion 620 of the GUI 601. Thus, step 523 includes determining at least one deciphered contact location based on the at least one ciphered contact location and the contact access key. Step 529 includes determining to send the at least one deciphered contact location associated with the contact to a location sharing client process different from the location sharing network service.

After sending the deciphered location in step 529, or if it is determined in step 527 that the request for the access key was not successful, control passes to step 531. In step 531, it is determined whether the subscriber wants to update the access key or list of privileged subscribers. For example, it is determined if the user of UE 101 has activated button 613c and accepted new entries into window 630. As another example, a user Edgar (service ID “Ed789”) wishes to retrieve Alice's location access key and initiates a request for Alice's permission. This step will be triggered by an operation such as a “friend request” on a LSS 118 and client 117. If Alice accepts Edgar's request, the location privacy manager module 150 issues a corresponding update message indicating “add user Ed789 to privileged subscribers list for LookingGlassXYZ” to the location key service 152. Alice's new privileged subscribers list will be “Bob456” and “Ed789.” Edgar may then retrieve Alice's location access key from the location key service 152. If an update is desired, then control passes back to step 507 to send an update message to the location key service 152. If not, then control passes to step 533.

In step 533, it is determined whether end conditions are satisfied. For example it is determined if the UE 101 is turned off, or the location sharing client 117 or service client 116 are closed. If so, the process ends. Otherwise, control passes back to step 511 and following to determine whether an invitation message, or location or ciphered location is received, as described above.

The processes described herein for secure revocable location sharing may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

FIG. 7 illustrates a computer system 700 upon which an embodiment of the invention may be implemented. Although computer system 700 is depicted with respect to a particular device or equipment, it is contemplated that other devices or equipment (e.g., network elements, servers, etc.) within FIG. 7 can deploy the illustrated hardware and components of system 700. Computer system 700 is programmed (e.g., via computer program code or instructions) to provide secure revocable location sharing as described herein and includes a communication mechanism such as a bus 710 for passing information between other internal and external components of the computer system 700. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 700, or a portion thereof, constitutes a means for performing one or more steps of secure revocable location sharing.

A bus 710 includes one or more parallel conductors of information so that information is transferred quickly among devices coupled to the bus 710. One or more processors 702 for processing information are coupled with the bus 710.

A processor (or multiple processors) 702 performs a set of operations on information as specified by computer program code related to secure revocable location sharing. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 710 and placing information on the bus 710. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 702, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 700 also includes a memory 704 coupled to bus 710. The memory 704, such as a random access memory (RAM) or other dynamic storage device, stores information including processor instructions for secure revocable location sharing. Dynamic memory allows information stored therein to be changed by the computer system 700. RAM allows a unit of information stored at a location called a memory address to be stored and retrieved independently of information at neighboring addresses. The memory 704 is also used by the processor 702 to store temporary values during execution of processor instructions. The computer system 700 also includes a read only memory (ROM) 706 or other static storage device coupled to the bus 710 for storing static information, including instructions, that is not changed by the computer system 700. Some memory is composed of volatile storage that loses the information stored thereon when power is lost. Also coupled to bus 710 is a non-volatile (persistent) storage device 708, such as a magnetic disk, optical disk or flash card, for storing information, including instructions, that persists even when the computer system 700 is turned off or otherwise loses power.

Information, including instructions for secure revocable location sharing, is provided to the bus 710 for use by the processor from an external input device 712, such as a keyboard containing alphanumeric keys operated by a human user, or a sensor. A sensor detects conditions in its vicinity and transforms those detections into physical expression compatible with the measurable phenomenon used to represent information in computer system 700. Other external devices coupled to bus 710, used primarily for interacting with humans, include a display device 714, such as a cathode ray tube (CRT) or a liquid crystal display (LCD), or plasma screen or printer for presenting text or images, and a pointing device 716, such as a mouse or a trackball or cursor direction keys, or motion sensor, for controlling a position of a small cursor image presented on the display 714 and issuing commands associated with graphical elements presented on the display 714. In some embodiments, for example, in embodiments in which the computer system 700 performs all functions automatically without human input, one or more of external input device 712, display device 714 and pointing device 716 is omitted.

In the illustrated embodiment, special purpose hardware, such as an application specific integrated circuit (ASIC) 720, is coupled to bus 710. The special purpose hardware is configured to perform operations not performed by processor 702 quickly enough for special purposes. Examples of application specific ICs include graphics accelerator cards for generating images for display 714, cipherographic boards for enciphering and deciphering messages sent over a network, speech recognition, and interfaces to special external devices, such as robotic arms and medical scanning equipment that repeatedly perform some complex sequence of operations that are more efficiently implemented in hardware.

Computer system 700 also includes one or more instances of a communications interface 770 coupled to bus 710. Communication interface 770 provides a one-way or two-way communication coupling to a variety of external devices that operate with their own processors, such as printers, scanners and external disks. In general the coupling is with a network link 778 that is connected to a local network 780 to which a variety of external devices with their own processors are connected. For example, communication interface 770 may be a parallel port or a serial port or a universal serial bus (USB) port on a personal computer. In some embodiments, communications interface 770 is an integrated services digital network (ISDN) card or a digital subscriber line (DSL) card or a telephone modem that provides an information communication connection to a corresponding type of telephone line. In some embodiments, a communication interface 770 is a cable modem that converts signals on bus 710 into signals for a communication connection over a coaxial cable or into optical signals for a communication connection over a fiber optic cable. As another example, communications interface 770 may be a local area network (LAN) card to provide a data communication connection to a compatible LAN, such as Ethernet. Wireless links may also be implemented. For wireless links, the communications interface 770 sends or receives or both sends and receives electrical, acoustic or electromagnetic signals, including infrared and optical signals, that carry information streams, such as digital data. For example, in wireless handheld devices, such as mobile telephones like cell phones, the communications interface 770 includes a radio band electromagnetic transmitter and receiver called a radio transceiver. In certain embodiments, the communications interface 770 enables connection to the communication network 105 for secure revocable location sharing with the UE 101.

The term “computer-readable medium” as used herein refers to any medium that participates in providing information to processor 702, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 708. Volatile media include, for example, dynamic memory 704. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 720.

Network link 778 typically provides information communication using transmission media through one or more networks to other devices that use or process the information. For example, network link 778 may provide a connection through local network 780 to a host computer 782 or to equipment 784 operated by an Internet Service Provider (ISP). ISP equipment 784 in turn provides data communication services through the public, world-wide packet-switching communication network of networks now commonly referred to as the Internet 790.

A computer called a server host 792 connected to the Internet hosts a process that provides a service in response to information received over the Internet. For example, server host 792 hosts a process that provides information representing video data for presentation at display 714. It is contemplated that the components of system 700 can be deployed in various configurations within other computer systems, e.g., host 782 and server 792.

At least some embodiments of the invention are related to the use of computer system 700 for implementing some or all of the techniques described herein. According to one embodiment of the invention, those techniques are performed by computer system 700 in response to processor 702 executing one or more sequences of one or more processor instructions contained in memory 704. Such instructions, also called computer instructions, software and program code, may be read into memory 704 from another computer-readable medium such as storage device 708 or network link 778. Execution of the sequences of instructions contained in memory 704 causes processor 702 to perform one or more of the method steps described herein. In alternative embodiments, hardware, such as ASIC 720, may be used in place of or in combination with software to implement the invention. Thus, embodiments of the invention are not limited to any specific combination of hardware and software, unless otherwise explicitly stated herein.

The signals transmitted over network link 778 and other networks through communications interface 770, carry information to and from computer system 700. Computer system 700 can send and receive information, including program code, through the networks 780, 790 among others, through network link 778 and communications interface 770. In an example using the Internet 790, a server host 792 transmits program code for a particular application, requested by a message sent from computer 700, through Internet 790, ISP equipment 784, local network 780 and communications interface 770. The received code may be executed by processor 702 as it is received, or may be stored in memory 704 or in storage device 708 or other non-volatile storage for later execution, or both. In this manner, computer system 700 may obtain application program code in the form of signals on a carrier wave.

Various forms of computer readable media may be involved in carrying one or more sequence of instructions or data or both to processor 702 for execution. For example, instructions and data may initially be carried on a magnetic disk of a remote computer such as host 782. The remote computer loads the instructions and data into its dynamic memory and sends the instructions and data over a telephone line using a modem. A modem local to the computer system 700 receives the instructions and data on a telephone line and uses an infra-red transmitter to convert the instructions and data to a signal on an infra-red carrier wave serving as the network link 778. An infrared detector serving as communications interface 770 receives the instructions and data carried in the infrared signal and places information representing the instructions and data onto bus 710. Bus 710 carries the information to memory 704 from which processor 702 retrieves and executes the instructions using some of the data sent with the instructions. The instructions and data received in memory 704 may optionally be stored on storage device 708, either before or after execution by the processor 702.

FIG. 8 illustrates a chip set or chip 800 upon which an embodiment of the invention may be implemented. Chip set 800 is programmed to provide secure revocable location sharing as described herein and includes, for instance, the processor and memory components described with respect to FIG. 7 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 800 can be implemented in a single chip. It is further contemplated that in certain embodiments the chip set or chip 800 can be implemented as a single “system on a chip.” It is further contemplated that in certain embodiments a separate ASIC would not be used, for example, and that all relevant functions as disclosed herein would be performed by a processor or processors. Chip set or chip 800, or a portion thereof, constitutes a means for performing one or more steps of providing user interface navigation information associated with the availability of functions. Chip set or chip 800, or a portion thereof, constitutes a means for performing one or more steps of secure revocable location sharing.

In one embodiment, the chip set or chip 800 includes a communication mechanism such as a bus 801 for passing information among the components of the chip set 800. A processor 803 has connectivity to the bus 801 to execute instructions and process information stored in, for example, a memory 805. The processor 803 may include one or more processing cores with each core configured to perform independently. A multi-core processor enables multiprocessing within a single physical package. Examples of a multi-core processor include two, four, eight, or greater numbers of processing cores. Alternatively or in addition, the processor 803 may include one or more microprocessors configured in tandem via the bus 801 to enable independent execution of instructions, pipelining, and multithreading. The processor 803 may also be accompanied with one or more specialized components to perform certain processing functions and tasks such as one or more digital signal processors (DSP) 807, or one or more application-specific integrated circuits (ASIC) 809. A DSP 807 typically is configured to process real-world signals (e.g., sound) in real time independently of the processor 803. Similarly, an ASIC 809 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 800 includes merely one or more processors and some software and/or firmware supporting and/or relating to and/or for the one or more processors.

The processor 803 and accompanying components have connectivity to the memory 805 via the bus 801. The memory 805 includes both dynamic memory (e.g., RAM, magnetic disk, writable optical disk, etc.) and static memory (e.g., ROM, CD-ROM, etc.) for storing executable instructions that when executed perform the inventive steps described herein to provide secure revocable location sharing. The memory 805 also stores the data associated with or generated by the execution of the inventive steps.

FIG. 9 is a diagram of exemplary components of a mobile terminal (e.g., handset) for communications, which is capable of operating in the system of FIG. 1, according to one embodiment. In some embodiments, mobile terminal 901, or a portion thereof, constitutes a means for performing one or more steps of secure revocable location sharing. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 903, a Digital Signal Processor (DSP) 905, and a receiver/transmitter unit including a microphone gain control unit and a speaker gain control unit. A main display unit 907 provides a display to the user in support of various applications and mobile terminal functions that perform or support the steps of secure revocable location sharing. The display 907 includes display circuitry configured to display at least a portion of a user interface of the mobile terminal (e.g., mobile telephone). Additionally, the display 907 and display circuitry are configured to facilitate user control of at least some functions of the mobile terminal. An audio function circuitry 909 includes a microphone 911 and microphone amplifier that amplifies the speech signal output from the microphone 911. The amplified speech signal output from the microphone 911 is fed to a coder/decoder (CODEC) 913.

A radio section 915 amplifies power and converts frequency in order to communicate with a base station, which is included in a mobile communication system, via antenna 917. The power amplifier (PA) 919 and the transmitter/modulation circuitry are operationally responsive to the MCU 903, with an output from the PA 919 coupled to the duplexer 921 or circulator or antenna switch. The PA 919 also couples to a battery interface and power control unit 920.

In use, a user of mobile terminal 901 speaks into the microphone 911 and his or her voice along with any detected background noise is converted into an analog voltage. The analog voltage is then converted into a digital signal through the Analog to Digital Converter (ADC) 923. The control unit 903 routes the digital signal into the DSP 905 for processing therein, such as speech encoding, channel encoding, enciphering, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like.

The encoded signals are then routed to an equalizer 925 for compensation of any frequency-dependent impairments that occur during transmission though the air such as phase and amplitude distortion. After equalizing the bit stream, the modulator 927 combines the signal with a RF signal generated in the RF interface 929. The modulator 927 generates a sine wave by way of frequency or phase modulation. In order to prepare the signal for transmission, an up-converter 931 combines the sine wave output from the modulator 927 with another sine wave generated by a synthesizer 933 to achieve the desired frequency of transmission. The signal is then sent through a PA 919 to increase the signal to an appropriate power level. In practical systems, the PA 919 acts as a variable gain amplifier whose gain is controlled by the DSP 905 from information received from a network base station. The signal is then filtered within the duplexer 921 and optionally sent to an antenna coupler 935 to match impedances to provide maximum power transfer. Finally, the signal is transmitted via antenna 917 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile terminal 901 are received via antenna 917 and immediately amplified by a low noise amplifier (LNA) 937. A down-converter 939 lowers the carrier frequency while the demodulator 941 strips away the RF leaving only a digital bit stream. The signal then goes through the equalizer 925 and is processed by the DSP 905. A Digital to Analog Converter (DAC) 943 converts the signal and the resulting output is transmitted to the user through the speaker 945, all under control of a Main Control Unit (MCU) 903—which can be implemented as a Central Processing Unit (CPU) (not shown).

The MCU 903 receives various signals including input signals from the keyboard 947. The keyboard 947 and/or the MCU 903 in combination with other user input components (e.g., the microphone 911) comprise a user interface circuitry for managing user input. The MCU 903 runs a user interface software to facilitate user control of at least some functions of the mobile terminal 901 to provide secure revocable location sharing. The MCU 903 also delivers a display command and a switch command to the display 907 and to the speech output switching controller, respectively. Further, the MCU 903 exchanges information with the DSP 905 and can access an optionally incorporated SIM card 949 and a memory 951. In addition, the MCU 903 executes various control functions required of the terminal. The DSP 905 may, depending upon the implementation, perform any of a variety of conventional digital processing functions on the voice signals. Additionally, DSP 905 determines the background noise level of the local environment from the signals detected by microphone 911 and sets the gain of microphone 911 to a level selected to compensate for the natural tendency of the user of the mobile terminal 901.

The CODEC 913 includes the ADC 923 and DAC 943. The memory 951 stores various data including call incoming tone data and is capable of storing other data including music data received via, e.g., the global Internet. The software module could reside in RAM memory, flash memory, registers, or any other form of writable storage medium. The memory device 951 may be, but not limited to, a single memory, CD, DVD, ROM, RAM, EEPROM, optical storage, or any other non-volatile storage medium capable of storing digital data.

An optionally incorporated SIM card 949 carries, for instance, important information, such as the cellular phone number, the carrier supplying service, subscription details, and security information. The SIM card 949 serves primarily to identify the mobile terminal 901 on a radio network. The card 949 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising:
determining a first identifier for a subscriber at a first service;
determining an access key stored at a second service in association with a second identifier for the subscriber;
determining at least one ciphered location based on the access key and at least one location associated with the subscriber; and
determining to send the at least one ciphered location to the first service in association with the first identifier.

2. A method of claim 1, wherein the first service is a location sharing network service and the second service is a key service.

3. A method of claim 1, wherein the second identifier for the subscriber is identical to the first identifier for the subscriber.

4. A method of claim 1, wherein the second identifier for the subscriber is different from the first identifier for the subscriber.

5. A method of claim 1, further comprising determining to send a location sharing invitation message to at least one contact of the subscriber, wherein the location sharing invitation message comprises data that indicates the first identifier for the subscriber and the second identifier for the subscriber.

6. A method of claim 1, further comprising receiving the at least one location associated with the subscriber from a client process different from the first service.

7. A method of claim 1, further comprising:
receiving at least one location sharing invitation message indicating a corresponding contact of the subscriber, wherein the at least one location sharing invitation message comprises data that indicates a third identifier for the contact at the first service and a fourth identifier for the contact at the second service;
determining to send to the second service a request for an access key associated with the fourth identifier; and
receiving a contact access key in response to sending the request.

8. A method of claim 7, wherein the fourth identifier for the contact is identical to the third identifier for the contact.

9. A method of claim 7, wherein the fourth identifier for the contact is different from the third identifier for the contact.

10. A method of claim 7, further comprising:
receiving, from the first service, at least one ciphered contact location associated with the third identifier; and
determining at least one deciphered contact location based on the at least one ciphered contact location and the contact access key.

11. A method of claim 10, further comprising determining to send the at least one deciphered contact location associated with the contact to a client process different from the first service.

12. A method of claim 1, further comprising determining to send to the second service a third identifier indicating at least one contact of the subscriber.

13. A method comprising:
determining to associate a first identifier for a subscriber with an access key and at least one second identifier at a network service for a contact of the subscriber,
wherein the access key is not associated with the first identifier at the network service.

14. A method of claim 13, further comprising:
receiving a request message for the access key, wherein the request message indicates the first identifier;
determining whether an identifier for a sender of the request message is included in the at least one second identifier associated with the first identifier; and
if the identifier for the sender is included in the at least one second identifier, then determining to send the access key associated with the first identifier in response to the request message.

15. An apparatus comprising:
at least one processor; and
at least one memory including computer program code for one or more programs,
the at least one memory and the computer program code configured to, with the at least one processor, cause the apparatus to perform at least the following,
determine a first identifier for a subscriber at a first service;
determine a location access key stored at a second service in association with a second identifier for the subscriber;
determine at least one ciphered location based on the location access key and at least one location associated with the subscriber; and
determining to send the at least one ciphered location to the first service in association with the first identifier.

16. An apparatus of claim 15, wherein the apparatus is further caused to determine to send at least one location sharing invitation message to a corresponding contact of the subscriber, wherein the location sharing invitation message comprises data that indicates the first identifier for the subscriber and the second identifier for the subscriber.

17. An apparatus of claim 15, wherein the apparatus is further caused to:
receive at least one location sharing invitation message indicating a corresponding contact of the subscriber, wherein the location sharing invitation message comprises data that indicates a third identifier for the contact at the first service and a fourth identifier for the contact at the second service;
determine to send to the second service a request for an access key associated with the fourth identifier; and
receive a contact access key in response to sending the request.

18. An apparatus of claim 17, wherein the apparatus is further caused to:
receive, from the first service, at least one ciphered contact location associated with the third identifier; and
determine at least one deciphered contact location based on the at least one ciphered contact location and the contact access key.

19. An apparatus of claim 15, wherein the apparatus is a mobile phone further comprising:
user interface circuitry and user interface software configured to facilitate user control of at least some functions of the mobile phone through use of a display and configured to respond to user input; and
a display and display circuitry configured to display at least a portion of a user interface of the mobile phone, the display and display circuitry configured to facilitate user control of at least some functions of the mobile phone.

20. An apparatus comprising:
at least one processor; and
at least one memory including computer program code for one or more programs,
the at least one memory and the computer program code configured to, with the at least one processor, cause the apparatus to perform at least the following,
determine to associate a first identifier for a subscriber with an access key and at least one second identifier at a first service for a contact of the subscriber,
wherein the access key is not associated with the first identifier at the first service.

21.-54. (canceled)
